(19) United States
(12) Patent Application Publication
(10) Pub. No.: US 2005/0108064 A1
(43) Pub. Date: May 19, 2005

(54) Methods and apparatus for developing and marketing combined insurance packages

(75) Inventors: James Castleman, Raleigh, NC (US); Cecil Lewis Fain, Raleigh, NC (US)

Correspondence Address: PRIEST & GOLDSTEIN PLLC, 5015 SOUTHPARK DRIVE, SUITE 230, DURHAM, NC, 27713-7736, US

(73) Assignee: GE Mortgage Holdings, LLC, Raleigh, NC (US)

(21) Appl. No.: 10/714,281

(22) Filed: Nov. 14, 2003

(51) Int. Cl. G06F 17/60

(52) U.S. Cl. 705/4

(57) ABSTRACT

Systems and techniques for designing and marketing combined insurance packages are described. A system according to one aspect of the present invention provides for assembling and marketing insurance packages including a combination of mortgage insurance and one or more other insurance components and comprises a risk data repository for storing risk information to be used in determining the risk and cost of providing insurance packages and an insurance data repository including information about available insurance components. The insurance data repository includes information about a mortgage insurance component and other insurance components. The system further comprises a risk evaluator for determining risks and costs associated with providing insurance, the risk evaluator being operative to compute overall risk and cost for a combined package and adjust parameters of the package components to optimize the risk and cost of the package.

### FIELD OF THE INVENTION

The present invention relates generally to advantageous systems and techniques for the marketing of financial service products. More particularly, the invention relates to systems and techniques for assembling and marketing combined packages providing mortgage insurance and job loss protection or some other insurance or financial product that may suitably be combined with mortgage insurance.

### BACKGROUND OF THE INVENTION

The purchase or financing of a home by a consumer is a substantial transaction. A mortgage loan is typically quite large and is expected to be repaid over many years. A continuing risk of borrower default is present during the repayment period. In addition, a default and foreclosure is a costly event for the mortgage holder, typically involving some months of missed interest payments, fees, possible depreciation of the property securing the mortgage, and sale expenses. Lenders typically require some protection against the costs of default. This protection may come in the form of a significant initial cash contribution by the borrower, typically at least 20% of the value of the property. In that case, the lender does not finance more than 80% of the value of the property and experience has shown that this “equity cushion” is usually sufficient to cover expenses associated with default and foreclosure.

However, many borrowers wish to finance a larger proportion of the value of the property. Traditionally, lenders who finance more than 80% of the value of a property have required a borrower to pay for private mortgage insurance in order to protect the lender. Such insurance is typically necessary in order to sell a mortgage loan to investors if the loan exceeds 80% of the value of the property. Private mortgage insurance covers the shortfall in the value of the property below the amount owed in the event of default and foreclosure.

Consumers do not attach a high value to private mortgage insurance. Mortgage insurance protects the mortgage holder, not the consumer, and consumers do not see how they benefit by paying for insurance to protect another party. Accordingly, consumers are extremely receptive to arrangements that allow them to avoid paying for mortgage insurance. One such arrangement, which has proven highly popular, is a financing arrangement wherein the borrower receives a first mortgage loan for 80% of the value of the property and a second mortgage loan for 10% of the value of the property. The borrower contributes the remaining 10% of the purchase price in cash. The holder of the first mortgage is only financing 80% of the purchase price, and therefore does not need to be protected by mortgage insurance, but the borrower does not need to raise cash for 10% of the purchase price. The interest on the second mortgage is frequently tax deductible, so that the tax advantages to the borrower offset a portion of the additional interest paid by the borrower. Traditional mortgage insurance does not offer any tax advantages, and the entire burden of the cost of the insurance is assumed by the borrower.

One disadvantage of financing using simultaneous first and second mortgage arrangements is that such arrangements are typically available only to borrowers with exceptionally good credit ratings, often manifested by a FAIR ISAAC AND COMPANY (FICO) score of 720-850. A borrower with such a credit rating is likely to consider alternatives to mortgage insurance, while a borrower with a lower credit rating may accept mortgage insurance with reluctance. A financial services company that could design and market mortgage insurance and related or associated products in ways that provided greater perceived value to consumers would gain a substantial competitive advantage.

One enhancement that may advantageously be combined with mortgage insurance is job loss protection. In uncertain economic times, consumers may feel reluctant to undertake a large purchase, such as the purchase of a home. If a consumer's mortgage insurance also provides protection against job loss, the consumer is more likely to feel that the risk is manageable, especially if the consumer expects to be able to find a new job while payments are still being made by the job loss protection policy.

There exists, therefore, a need for systems and techniques for designing and marketing mortgage insurance including added value components such as job loss protection, together with ways to market the products so that the increased value is easily perceived.

### SUMMARY OF THE INVENTION

In order to meet this need, as well as to provide other customer benefits, one aspect of the present invention comprises a process of assembling and marketing insurance packages including a combination of mortgage insurance and job loss insurance. The process may suitably comprise the steps of developing specifications for a mortgage insurance policy, developing specifications for a job loss insurance policy to make mortgage payments during a period of unemployment of a borrower obligated on a mortgage covered by the mortgage insurance policy, combining the mortgage insurance policy and the job loss insurance policy into a package, and pricing and marketing the package.

An alternative aspect of the present invention provides a system for assembling and marketing insurance packages including a combination of mortgage insurance and additional insurance components, further comprising a risk data repository for storing risk information to be used in determining the risk and cost of providing insurance packages and an insurance data repository including information about available insurance components. The repository includes information about a mortgage insurance component and a other insurance components. The system further comprises a risk evaluator for determining risks and costs associated with providing insurance. The risk evaluator is operative to compute overall risk and cost for a combined package and adjust parameters of the package components to optimize the risk and cost of the package.

An alternative aspect of the invention comprises a method of developing and marketing combined packages of insurance including mortgage insurance and job loss insurance, comprising the steps of collecting and storing data related to risks and costs of providing insurance, developing and storing details of insurance components to be made available in the form of combined packages, the packages including a mortgage insurance component and a job loss insurance component, and evaluating risks and costs associated with providing a package of insurance including mortgage insurance and job loss insurance. The step of evaluation may suitably comprise evaluating each component of the package, evaluating the combined risk and cost of the package as a whole and adjusting parameters of the package to optimize the risk and cost of the package.

A more complete understanding of the invention, as well as further features and advantages of the invention, will be apparent from the following Detailed Description and from the claims which follow below.

### BRIEF DESCRIPTION OF THE DRAWINGS

FIG. 1 illustrates a process of assembling and marketing insurance packages including a combination of mortgage insurance and job loss insurance according to an aspect of the present invention;

FIG. 2 illustrates a system for designing and marketing insurance packages according to an aspect of the present invention;

FIG. 3 illustrates additional details of selected components of the system of FIG. 2;

FIG. 4 illustrates an exemplary form used to enter coverage parameters;

FIG. 5 illustrates an exemplary display used to present coverage details and costs in response to submission of a set of coverage parameters;

FIG. 6 illustrates an exemplary display used to present a summary of coverage parameters in order to allow commitment to a coverage package; and

FIG. 7 illustrates a process of insurance package pricing, assembly and promotion according to an aspect of the present invention.

### DETAILED DESCRIPTION

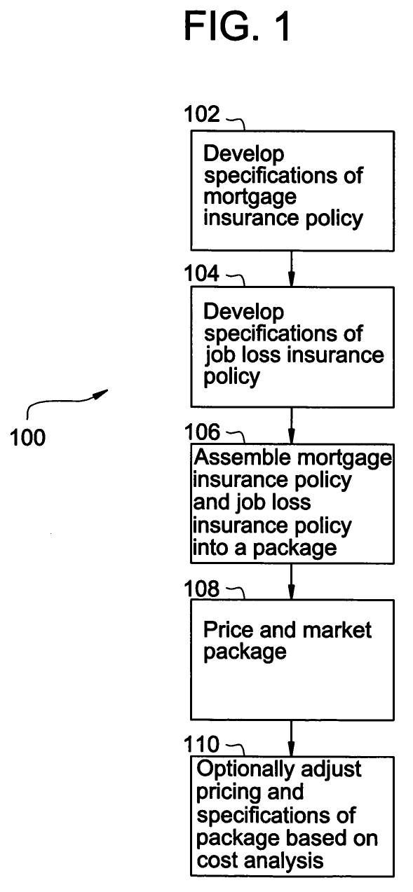

FIG. 1 illustrates a process 100 of assembling and marketing a combined mortgage insurance and job loss package according to an aspect of the present invention. At step 102, specifications of a mortgage insurance policy are developed. The specifications preferably include coverage, exclusions and limitations consistent with those common in the industry. At step 104, specifications for a job loss insurance policy to be offered in combination with the mortgage insurance policy are developed. The job loss policy covers involuntary unemployment by one or more borrowers obligated on a mortgage loan, suitably by paying the monthly payment due on the mortgage during a period of unemployment by a borrower. The number of payments that will be made is limited to a predetermined maximum. At step 106, the mortgage insurance policy and the job loss insurance policy are assembled into a package.

At step 108, the overall package is priced and marketed. Marketing and pricing of the policy may suitably be based on a need to be competitive with the pricing of alternative mortgage insurance products. Pricing is suitably based on the amount of the loan to be insured, as well as a consideration of the loan to value ratio, that is, the ratio of the amount of the loan to the value of the property securing the loan.

At optional step 110, pricing and specifications of the package may suitably be adjusted based on an analysis of the costs of providing the package components. This analysis may suitably take into account the effects of protection provided by the job loss component on the cost of providing the mortgage insurance component. The presence of the job loss protection reduces the likelihood that a default will occur on the mortgage, and therefore decreases the cost of furnishing the mortgage insurance component of the package. Advantageously, the price of a mortgage policy including job loss protection should be competitive with products that do not include job loss protection. It can be expected that at least some of the cost of providing job loss coverage will be paid for simply by the savings the provider realizes in a reduced cost of providing mortgage insurance. Analysis of the effects of the job loss protection on the cost of the mortgage insurance helps determine the coverage duration, exclusions and other parameters that a job loss package can have without excessively increasing the cost of the package over the cost of mortgage insurance products without job loss protection. It may be possible to provide some duration of job loss protection without experiencing any added cost for the package as a whole above a package that does not include job loss protection, or it may be determined that a higher price for a longer duration of job loss protection will be accepted by consumers. The cost for providing a package as a whole is likely to be less than the sum of the costs of each component of the package, considered separately. Design and pricing of the package can, if desired, take such facts into account.

It is also possible to collect and analyze risk and cost data and use the results of the analysis in order to design and promote packages including combined mortgage insurance and job loss protection. The risk analysis may be undertaken based on general data to be applied to all packages. As an alternative, it is also possible to receive individualized data from consumers in order to tailor a package to the particular circumstances of the consumer.

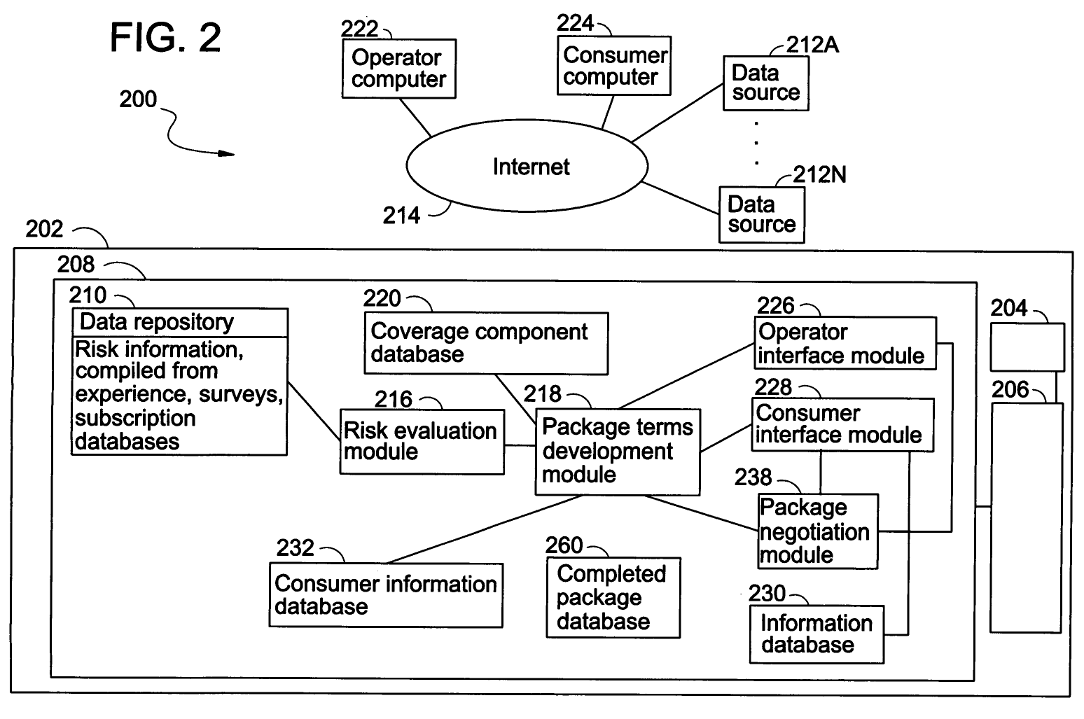

FIG. 2 illustrates a financial product design and marketing system 200 according to an aspect of the present invention. The system 200 preferably comprises a server 202, including a processor 204, memory 206 and long term storage 208. The server 202 suitably hosts various data repositories and databases preferably implemented as data files hosted in the long term storage 208, and modules, preferably stored in the long term storage 208 and executed under the control of the processor 204. The server 202 preferably hosts a data repository 210 including collected statistical information relating to risks involved in providing insurance products. For mortgage insurance products, the risks typically include the risk that a borrower will default on a mortgage loan and that a loss will be incurred as a result of such default. The risk of loss related to mortgage insurance depends on the risk that default will occur and, if default does occur, that a sale of the property will realize less than the amount owing on the mortgage. For job loss insurance, the risk may depend on the amount and number of payments that may be made as a result of involuntary unemployment of the covered party. Analysis of such a risk involves estimating the probability and duration of job loss, taking into account the size and frequency of payments that are to be made and the maximum number of payments to be made. For example, a job loss insurance policy may specify that a borrower's mortgage payment will be made for up to six months in the event that the borrower becomes involuntarily unemployed. The risk related to such insurance depends on factors such as the likelihood that the borrower will become unemployed, the amount of each payment to be made, and the expected duration of unemployment.

Statistical information may be gathered using a plurality of data collection sources such as the sources 212A . . . 212N. The sources 212A . . . 212N may furnish the information to the server 202 through a publicly accessible network such as the Internet 214. The data collection sources 212A . . . 212N suitably provide periodically updated data related to risks being insured against. Such data may include loss experience, industry reports and the like, and the data collection sources 212A . . . 212N may take any of a number of forms, such as computer workstations operated by data entry operators, connection points for the reception of subscription data or the like. Once the information is gathered and stored, it may be processed by a risk evaluation module 216, in order to determine the risk of events of interest, in order to design and price insurance products to provide protection against such risks. The risk evaluation module 216 receives information describing the particular risks to be insured against, and evaluates the risks using the received information as well as information extracted from the repository 202.

The risk evaluation module 216 is particularly useful in assembling packages of coverage. In some cases, protection provided by insurance against a particular risk may mitigate a related risk, and allow discounted pricing or added value for a package insuring such related risks together. For example, the risk evaluation module 216 may suitably be used to evaluate a combined package including a mortgage insurance component and a job loss insurance component. The job loss insurance component may be activated upon involuntary termination of the employment of a covered party, and make the covered party's mortgage payment during such unemployment, up to a specified maximum number of payments. The mortgage insurance component insures the party servicing the mortgage against default by the borrower. The protection provided by the job loss component of the package is likely to decrease the risk of default, therefore decreasing the cost of providing the mortgage insurance portion of the package.

Thus, it may be feasible to offer a combined package of job loss insurance and mortgage insurance at a price significantly lower than if the risk and costs of each element were considered in isolation. Therefore, the risk evaluation module 216 may suitably be used to weigh the overall costs involved in providing the package. The risk evaluation module 216 may also be used to evaluate actual or proposed changes in the various package components to determine the effects of the changes on the overall risk, and therefore cost, of providing the insurance components of the package. Such weighing of risks can provide important information that can be used to price and design services. For example, providing job loss insurance carries a cost based on the analysis of the risks. If the job loss insurance makes mortgage payments for the borrower during the borrower's unemployment, the cost of providing the insurance can be expected to increase as the maximum number of payments that can be made is increased. On the other hand, the fact that mortgage payments will be made during periods of unemployment decreases the risk of default. As the maximum number of payments that can be received under the job loss component increases, and especially as the number of payments that can be received during a single period of unemployment increases, the risk of providing the mortgage insurance component of the package decreases. These risks, and their costs, can be evaluated and balanced by the risk evaluation module 216 and the optimum terms for each component of the package can be chosen. Circumstances can be envisioned in which increasing the maximum number of payments that may be made during a period of unemployment will contribute a zero or negative increase in overall costs for the package, because the protection afforded by the job loss insurance will alleviate, or even completely offset or more than offset the risk and cost of providing the mortgage insurance. Evaluation of risks involved in providing a package may suitably be performed using generalized estimates relating to the entire population of potential customers. As an alternative, it is also possible to solicit individualized information from a potential customer and perform analyses based on that information.

The server 202 may also host a package terms development module 218, used to assemble a package including various components. Details of the coverage components may suitably be stored in a coverage components database 220. The package terms development module 218 may accept specified criteria as inputs and use data provided by the risk evaluation module 216 to design package terms meeting the specified criteria.

One exemplary criterion is competitiveness with other products. A provider of a package including mortgage insurance can be expected to want to price the product so that it will be competitive with other mortgage insurance products. The package terms development module 218 may be designed to allow a product designer to specify a desired price, for example, and then to develop a set of terms that can be offered at the specified price. This approach to development of terms may suitably include evaluating the cost of each component using the risk evaluation module 216. Evaluation is performed by submitting component terms to the module 216, receiving risk and cost information relating to those terms and progressively adjusting the terms of the package components, either singly or in combination until a package meeting the specified criteria is developed. If no package can be developed meeting the specified criteria, the module 218 may return information describing criteria that can be met.

The system 200 may suitably be accessible to operators using computers such as the operator computer 222, allowing the operator to develop packages by submitting desired criteria and receiving descriptions and cost information for packages meeting the desired criteria. Operators may suitably include employees of a mortgage insurance company, developing packages for marketing to consumers. In addition, employees of a lender having a business relationship with an insurance package provider may be given operator access in order to develop packages for their employer.

It may also be desired to offer consumers direct access to product information. Consumers may be allowed to review information relating to products generally available and priced according to standard criteria. For example, a package may provide six months of job loss protection in combination with mortgage insurance, and may be priced based on the loan amount and the loan to value ratio of an insured mortgage. In addition, it may be desired to offer products designed based on individualized criteria furnished by consumers. Therefore, the system 200 may be accessible to consumer operated computers, such as a consumer computer 224, in order to allow a consumer to obtain product information and to provide individualized information. Both the computers 222 and 224 may suitably gain access to the server 202 through the Internet 214, with appropriate security and authentication measures being taken in order to distinguish between classes of users of the system 200. For example, it is highly desirable to distinguish an internal operator using the computer 222 from a consumer using the computer 224, because the operator can be allowed much greater access to system features than can a typical consumer. Suitably, the system 200 includes an operator interface module 226 and a consumer interface module 228. The operator interface module 214 is preferably designed to offer a more efficient interface to an experienced user and to offer greater flexibility of operation. For example, the module 226 may allow an operator to construct packages to be offered for sale and to design displays and discussions about these packages. The consumer interface module 228 preferably includes an easy to use interface adapted to an inexperienced user and allows access that is restricted to a controlled set of information that is relevant to the user's specific needs or is of a general educational and promotional nature. The consumer interface module 228 preferably allows access to educational and promotional information that may be extracted from an information database 230 by the module 228 for presentation to the consumer. The educational and promotional information may include general descriptions of various kinds of insurance and their value. The educational and promotional information may also include descriptions of various products and packages that are available. The consumer interface module 228 may allow the consumer to submit information describing the consumer's needs. The consumer interface module 228 suitably provides the consumer with forms allowing submission of information describing the consumer's needs. The consumer interface module 228 submits the information to the package terms development module 218. The package terms development module retrieves appropriate products from the component database 220, assembles a package and transfers information relating to the package to the consumer interface module 228 for presentation to the consumer.

Preferably, any identifiable information provided by a consumer is protected using suitable security techniques, such as public key encryption. The consumer interface module 228 suitably receives information using information entry forms presented as hypertext pages. For example, in the case of mortgage insurance, a form might call for information such as desired loan amount, property value, property address and the like, as well as general selections for the type of insurance package desired. This information may be stored in a consumer information database 232 for retrieval and use in developing insurance packages based on requirements submitted by the consumer and for storing package information relating to a consumer. Once the package has been designed, and the risk and cost information for the package determined, the consumer interface module 228 may compute a price for the package and pass it to the consumer computer 224, preferably by constructing a hypertext page presenting the information and passing it to the computer 224 for display. Package details may also be stored in the consumer information database 230. Price computation may suitably be based on standard factors applicable to all consumers, such as the amount of the loan, the loan to value ratio and the particular product desired. If desired, however, the system 200 may be programmed or designed so that individual risk calculations are performed for individualized consumer information. If that is the case, the consumer interface module 228 may submit information provided by the consumer to the package terms development module 218, which invokes the risk evaluation module 216 to determine risk and cost information and develop suitable package terms and pricing.

If desired, a consumer may be permitted to commit to coverage once the coverage details have been examined. In that case, the consumer may indicate a desire to commit to a coverage package and the coverage details may be assembled by a package negotiation module 238. The coverage details may suitably be stored in a consumer information database 232 and a completed package database 260.

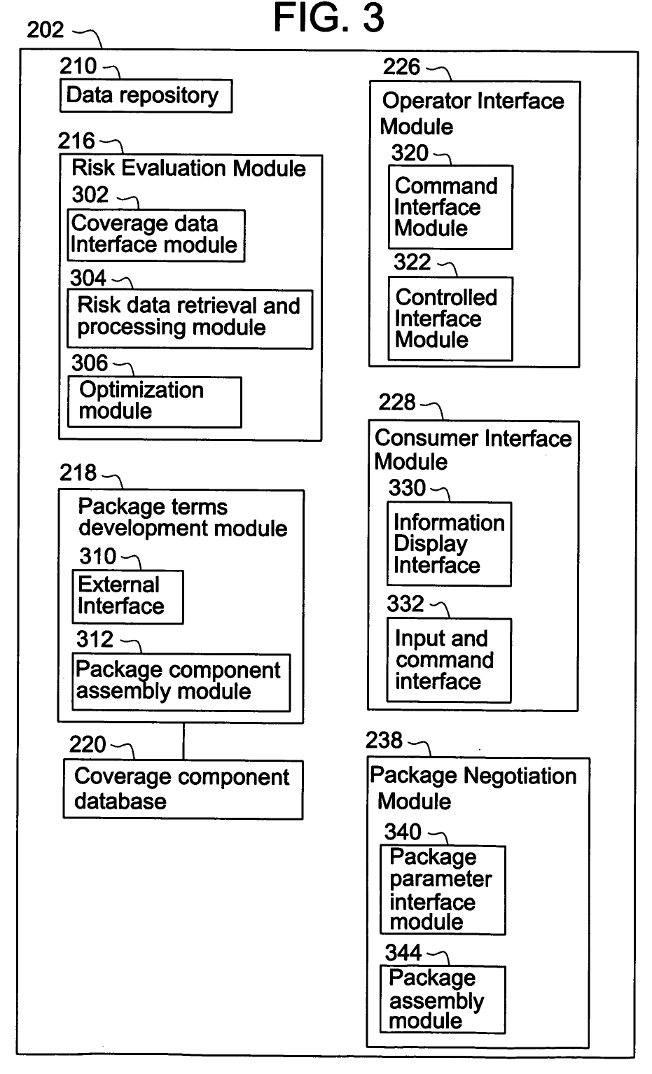

FIG. 3 illustrates additional details of the server 202, showing additional details of the risk evaluation module 216, the package terms development module 218, the operator interface module 226, the consumer interface module 228 and the package negotiation module 238. The risk evaluation module 216 suitably includes a coverage data interface module 302, allowing the submission of data such as a set of coverage requirements. The risk evaluation module 216 further includes a risk data retrieval and processing module 304, allowing extraction of data from the repository 210 in response to inputs received by the coverage data interface module 302 and processing the information in order to compute risk information for a particular aspect of coverage, for example. The data retrieval and processing module 304 is able to compute risk information for each aspect of coverage in a package. For example, the coverage requirements may include providing mortgage insurance for a loan of $200,000 at 6.0% and including a job loss protection policy covering up to a maximum of six months of payments during a period of unemployment of a borrower. The monthly payment for such a loan is approximately $1200, so that the maximum payment under the job loss protection component of the package would be $7200. The data retrieval and processing module 304 computes the cost of the mortgage insurance component and the job loss component by taking the possible payments and factoring in the risk that the payments will need to be made. In the case of the job loss component of the policy, the maximum payout of $7200 would be relatively unlikely because it would require a full six months of unemployment. Smaller payouts would be more likely, and the module 304 suitably uses data from the repository 210 to evaluate the costs of coverage, taking into account the potential payouts and their probability.

In addition, the presence of the job loss component of the package affects the likelihood of payment under the mortgage insurance policy. The data retrieval and processing module 304 computes the cost of the mortgage insurance and then discounts this cost by taking into account the reduced likelihood of default on the mortgage due to the job loss component of the package. This discounted cost of the mortgage insurance component is combined with the calculated cost of the job loss component to determine the overall cost of the package.

The cost information is then submitted to an optimization module 306. The optimization module 306 evaluates the various aspects of a package and then makes modifications to various parameters of the aspects of the package and examines the effects of the modifications on the overall cost of the package. Such modification and examination can result in improvements to the package at no cost or a relatively small cost, or can even result in a combination of increased protection at a lower overall cost of the package.

To continue the previous example, the optimization module might examine the effects of extending the maximum number of payments under the job loss component to 7. This would be accomplished by increasing the potential number of payments to 7 and submitting this increased number to the risk data retrieval and processing module. Under some circumstances, it might be discovered that an increase in the maximum number of payments under the job loss protection component resulted a zero increase, or even a decrease, in the overall cost of providing the package. It can be expected that an increase in cost due to an increased maximum number of payments under the job loss protection component would be at least partially offset by a decrease in the risk of default. A decrease in the risk of default would result in a lower cost for the mortgage insurance component of the package, and circumstances can be envisioned in which the decrease in the risk of default completely offset the added cost resulting from increasing the job loss protection.

The optimization module 306 continues to make and evaluate adjustments according to a predetermined arrangement. For example, adjustments may be made so as to minimize overall costs, adjustments may be made so as to achieve the maximum number of payments possible under the job loss component of the package without increasing overall package costs, or adjustments may be made so as to achieve the maximum number of payments possible under the job loss component of the package while staying within a specified cost constraint. The optimization module 306 then returns information describing the overall cost of providing the package, the cost associated with each package component and the parameters of each package component once optimization has been accomplished.

The package terms development module 218 includes an external interface 310 and a package component assembly module 312. The external interface 310 receives inputs such as descriptions of desired features of a coverage package. The desired features may suitably include desired areas of coverage, overall package pricing and the like. The package component assembly module 312 retrieves coverage components from the database 220 and submits the coverage criteria and the coverage components to the risk evaluation module 206. The package component assembly module 312 then receives optimized package terms from the risk evaluation module 216 and returns the package terms using the external interface module 310.

The operator interface module 226 includes a command interface module 320 and a controlled interface module 322. The command interface module 320 allows direct access to various elements of the server 202. For example, the command interface module 320 allows the operator to examine the coverage component database 220 directly and to submit various coverage components and criteria to the risk evaluation module 106 in order to assemble a package. The controlled interface module 322 allows operation in a prescribed way using forms assembled from a form database 324, and with information presented to the operator by the assembly and presentation of forms and displays.

The consumer interface module 228 includes an information display interface 330, providing access to educational and promotional information. The information display interface 330 allows access by the consumer to the information database 230, suitably through a sequence of hypertext pages with links to appropriate information in the information database 230. The consumer interface module 228 also includes an information and command entry interface 332. The information and command entry interface 332 provides a relatively tightly controlled mechanism for the consumer to provide information to the system 200 and to issue commands in order to receive specific coverage package information and, in appropriate circumstances, to select coverage for a specific requirement. The information and command entry interface 332 preferably operates through the presentation of forms to the consumer for data entry and submission of selections and commands and through the presentation of forms and displays for presentation of information to the consumer.

The package negotiation module 238 includes a package parameter interface module 340, for receiving information describing components required in a package. This information may suitably come from the operator interface module 226 or the consumer interface module 228. The package negotiation module 238 further includes a package assembly module 344, for assembling various components selected by an operator or consumer. For example, the parties to a set of package components may be a consumer and a package provider.

Once commitments for a package have been negotiated, the package negotiation module 238 suitably stores commitment information in the completed package database 260 of FIG. 1. Suitably, the database 260 includes a record for each package for which a coverage agreement has been negotiated. The record for a package suitably includes details of each coverage component of the package, the effective coverage date for the package, the cost information for each component and for the package as a whole, the date and time at which commitment occurred and the identities of the parties to the package.

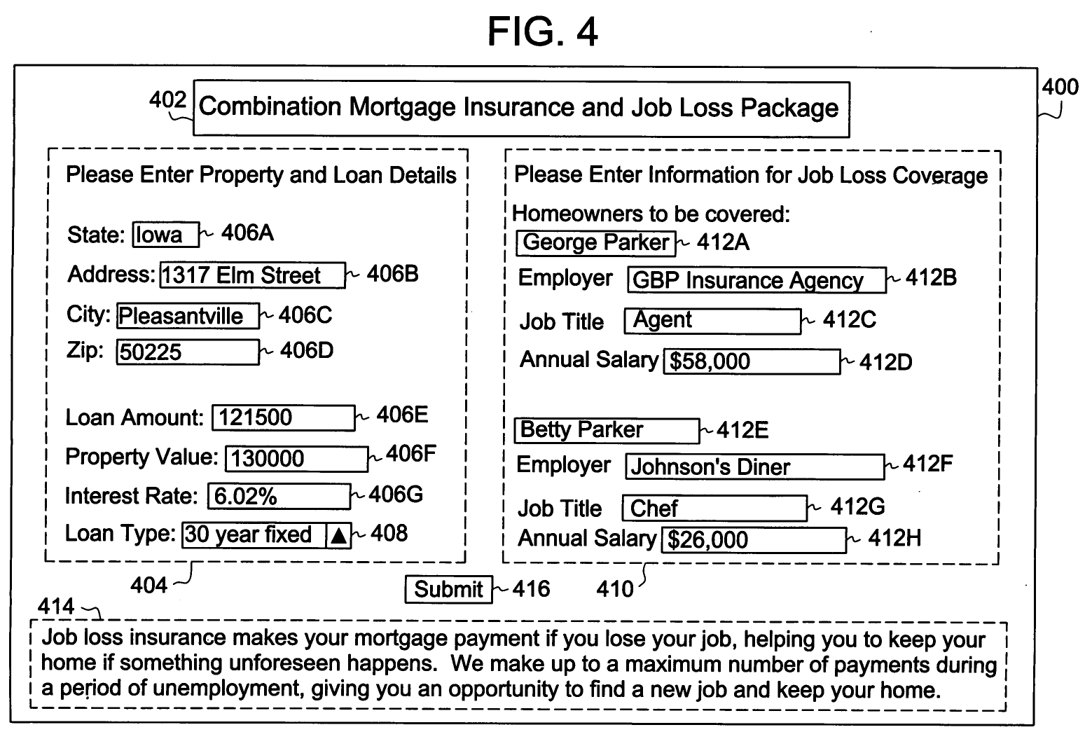

FIG. 4 illustrates a form 400, allowing submission of information to the system 200 in order to allow risk and cost assessment for a specific set of circumstances and return of information describing available coverage for the specified set of circumstances. The form 400 may suitably be presented by the operator interface 226 or the consumer interface 228, and may take the form of a hypertext page for display using a browser hosted on a computer such as the operator computer 222 or the consumer computer 224 of FIG. 2. The form 400 includes a caption 402, a property and loan information entry area 404, including fields 406A-406D for property address information, fields 306E-406G for loan information and a scrolldown list 408 for the loan type. The loan type is one of a relatively small number of available loan types, including fixed and adjustable loans having various parameters, so that a scrolldown menu is appropriate for entering this information.

The form 400 also includes a job loss information area 410, including fields 412A-412D and 412E-412H for entry of information about homeowners to whom the job loss protection is to apply. The form 400 further includes an explanatory information area 414 and a “submit” button 416. A user enters the requested information in the appropriate fields and clicks the “submit” button to pass the information to the package terms development module 218. This submission may suitably be accomplished by passing the information to the consumer information database 218 of FIG. 1, where the information is accessible to the package terms development module 218. The package terms development module 218 retrieves the submitted information from the database 232, develops general parameters for the package to provide the coverage required in light of the information and invokes the risk evaluation module 216 to assess the risk and cost of the required coverage and to adjust the parameters for risk and cost optimization. The risk and cost of the coverage are computed through analyzing the costs and likelihood of default on the mortgage and the likelihood and cost of payment under the job loss protection component of the coverage, taking into account the fact that the job loss protection lowers the risk of default. Adjustments to various parameters of the package are tested to determine their effect on the overall cost. For example, it may be possible in some cases to increase the number of payments that can be made under the job loss protection component, without increasing the overall cost of the package. The increase in cost of the increased job loss protection may be offset by the decrease in risk, and therefore cost, of the mortgage insurance component afforded by the increase in the job loss protection. Once the risk and cost computations have been performed, the risk evaluation module 216 returns the cost information and adjusted parameters to the package terms development module 218. The package terms development module 208 passes the package terms to the operator interface 226 or the consumer interface 228, depending on which of the interfaces 226 and 228 invoked it. In the present case, the form 300 is more likely to have been submitted by a consumer using the interface 228. In such a case, the consumer interface module 116 would prepare a suitable display to present the information to the consumer.

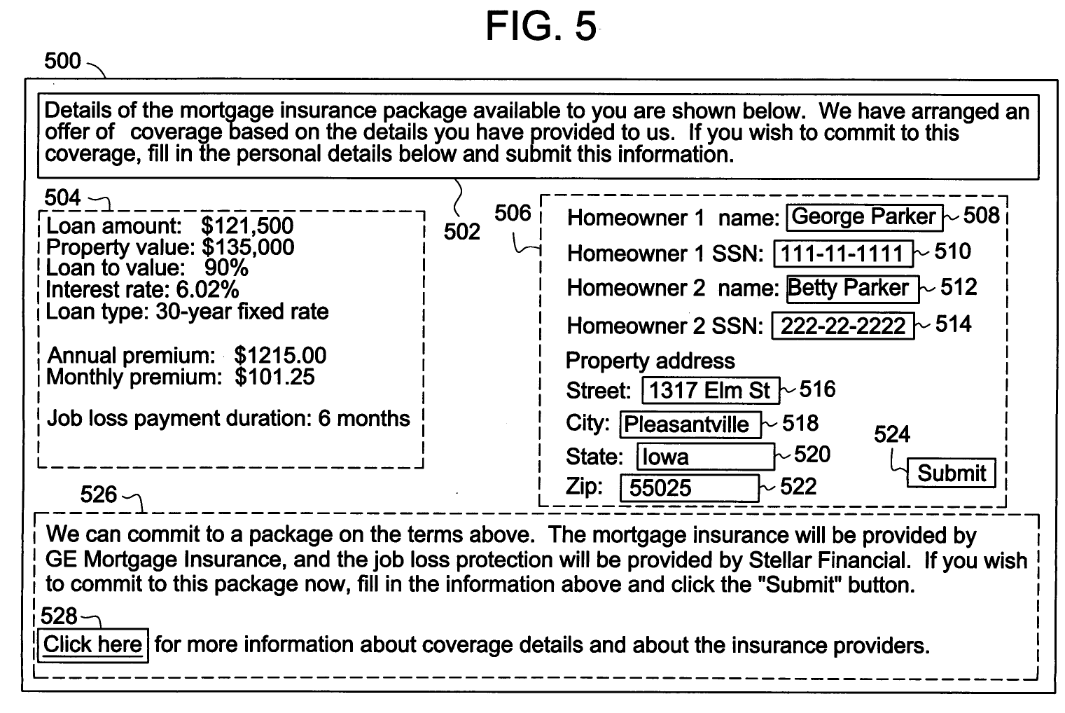

FIG. 5 illustrates a display 500, generated after a set of terms for a coverage package has been generated by the package terms development module 218. The display 500 may suitably be presented in the form of a hypertext page for display by a hypertext browser hosted on a computer such as the computer 222 or 224. The display 500 includes a caption 502, a mortgage insurance coverage section 504, a job loss information entry section 506 including information entry fields 508-522, and a “Submit” button 524. The mortgage insurance coverage section 504 displays previously stored information submitted by a consumer or otherwise submitted in relation to a transaction. This information includes property address and mortgage information. The mortgage insurance coverage section further displays coverage information computed by the package terms development module 218. Here, this information is the annual and monthly premium for the coverage package, as well as the maximum number of payments that will be made in the event of job loss. The display 500 can also be used to enter into a commitment for coverage on the terms described. Thus, the job loss information entry section 506 includes 508-522 for entry of information not previously submitted, and a “Submit” button 524 to submit the information and indicate a desire to commit to coverage as described in the section 504. The information section 526 includes additional details, such as the identities of the parties providing the coverage components, together with a link 528 allowing the display of further information.

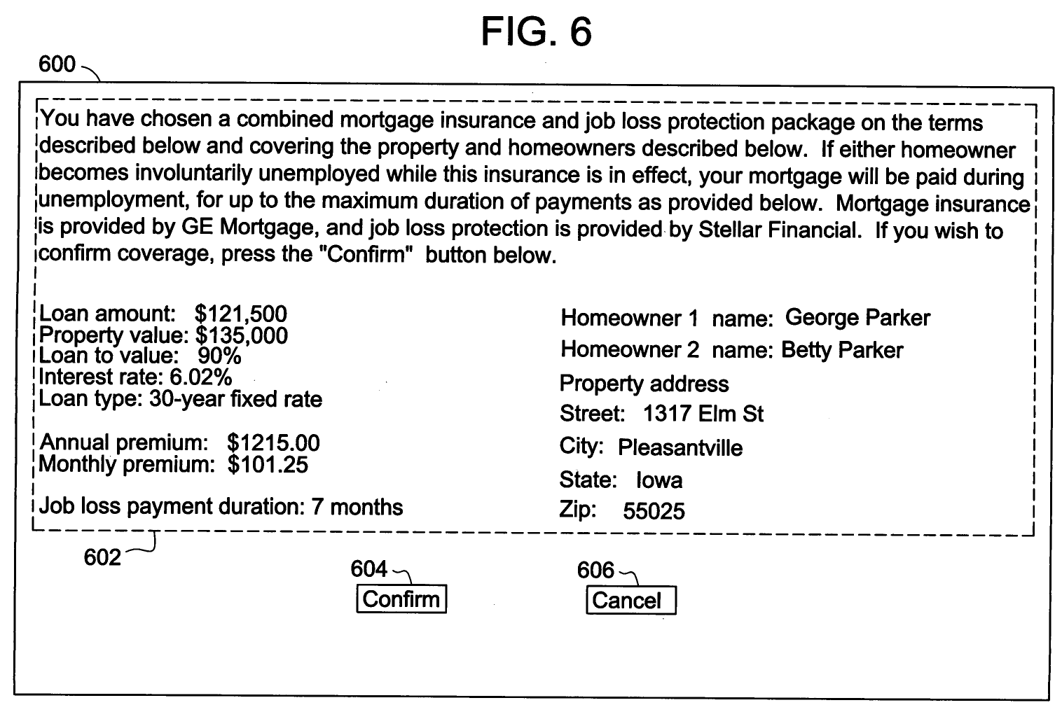

FIG. 6 illustrates a display 600, presented after activation of the “submit” button 524 of FIG. 5. The display 600 includes a coverage description area 602, presenting details about the proposed coverage package, in order to give a user an opportunity to review the package before entering into a commitment. The display 600 also includes a “Confirm” button 604 and a “Cancel” button 606. If the user activates the “Cancel” button, no commitment information is submitted and a suitable display is presented indicating that no coverage package has been entered into. If the “Confirm” button 604 is activated, commitment information is stored in the database 232 of FIG. 2 and the completed package database 260 of FIG. 2 and relayed to responsible parties for action. For example, a set of documents may be prepared for inclusion in a loan package being prepared in connection with the insurance package.

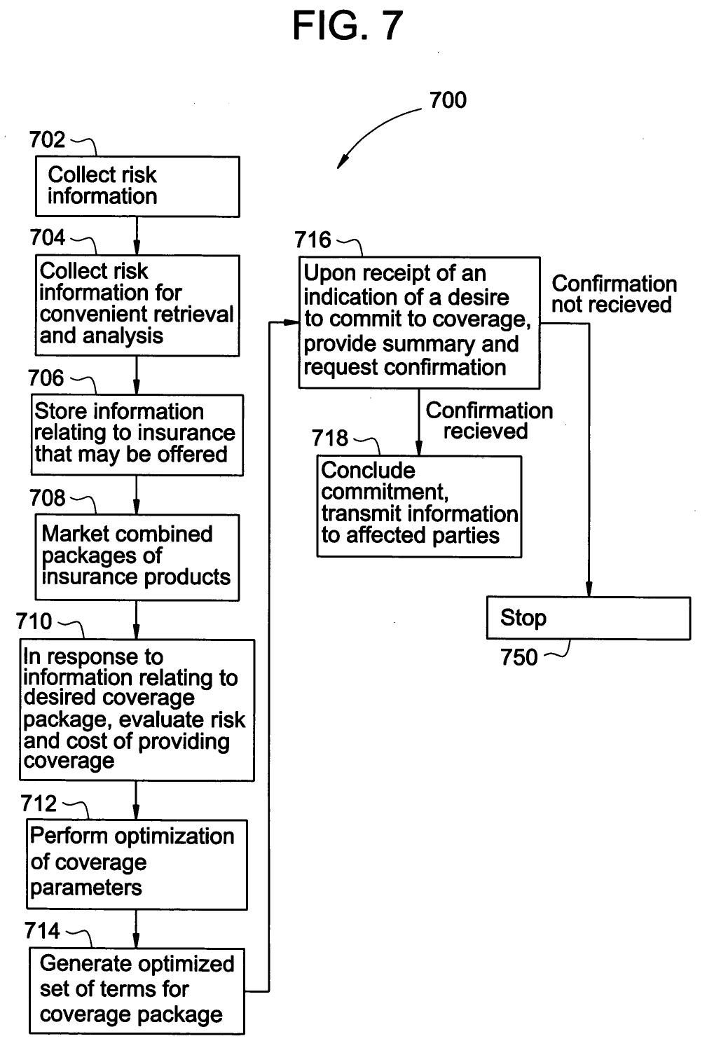

FIG. 7 illustrates a process 700 of insurance package evaluation, pricing and marketing according to an aspect of the present invention. The process 700 may be carried out using a system such as the system 200 of FIG. 2. At step 702, risk information is collected for use in evaluating risk to be insured. This information may take numerous forms, such as direct loss experience of an insurer, actuarial data, surveys, or the like. The information may come from numerous different sources, such as data entry operators, subscription data services, harvesting of relevant information when insurance losses are paid and as many other sources as are suitable and desired for use in assembling predictive data. At step 704, the risk information is assembled and stored for convenient retrieval. At step 706, information relating to various forms of insurance that may be used to create combined insurance packages is stored. The information may suitably include risks to be covered by each component, exclusions and limitations of each component, persons who qualify for coverage, or the like. Suitable components for which information is stored include mortgage insurance protecting a lender in the event of default on a mortgage, and job loss insurance, providing for direct payment to a covered party or for payment or deferral of mortgage payments or other debts in the event of job loss. At step 708, marketing is performed relating to combined packages of insurance. One suitable form of package is a combined package of mortgage insurance and job loss insurance, with the mortgage insurance component protecting a lender in the event of default on a mortgage and the job loss component providing payment of monthly mortgage payments owed on a mortgage issued in connection with the package. Promotion may be accomplished by providing materials to lenders, through direct consumer promotion, through establishing websites providing promotional and educational information and by numerous other means. At step 710, in response to the presentation of information describing specific coverage needs for a package of coverage components, evaluation of the risk and cost of delivering each of the components is performed. Evaluation is accomplished by examining the coverage desired and using the stored risk data to compute the risks and cost of providing coverage on the terms desired. In addition, the risk and cost of the package as a whole is evaluated by taking into account the effect of each coverage component on the risks and costs involved in providing the other coverage components. At step 712, optimization of coverage parameters is performed. Adjustment of parameters of the coverage package are made and their effects on the risk and cost presented by the package as a whole are evaluated. For example, in a package combining job loss protection and mortgage insurance, increasing the job loss protection is likely to decrease the risk involved with the mortgage insurance, with the cost of the mortgage insurance possibly decreasing sufficiently to allow an increase in the amount of job loss protection without an increase in the overall cost of the package.

At step 714, an optimized set of terms for a coverage package is generated. At step 716, upon a receipt of an indication of a decision to commit to coverage on the terms described, a summary of the proposed coverage and terms is presented for confirmation. If an indication is received that a commitment to coverage is not desired, the process terminates at step 750. If an instruction to commit to coverage is received, the process proceeds to step 718 and a coverage commitment is concluded and suitable documentation is prepared and transmitted to responsible parties. The documentation may come in the form of paper documents to be signed and returned, in the form of electronic indications that coverage has been committed to, or any other suitable form sufficient to document the existence of an agreement. Coverage details are suitably stored in a database record associated with a consumer to be covered, a marketer of insurance packages on the terms that have been committed to, or any other party entering into the coverage package. Coverage details relating to each component of the package are provided to and may be stored in a database record associated with the provider of that component.

While the present invention is disclosed in the context of aspects of an embodiment employing a specific system and exemplary web pages, and in the context of the specific combination of mortgage insurance with job loss protection, it will be recognized that a wide variety of implementations may be employed by persons of ordinary skill in the art consistent with the above discussion and the claims which follow below. By way of example, it will be recognized that mortgage insurance can be combined with other types of insurance or financial products to the extent that such combinations are deemed beneficial by consumers.

1. A method for assembling and marketing insurance packages including a combination of mortgage insurance and job loss insurance, comprising the steps of:
developing specifications for a mortgage insurance policy;
developing specifications for a job loss insurance policy to make mortgage payments during a period of unemployment of a borrower obligated on a mortgage covered by the mortgage insurance policy;
combining the mortgage insurance policy and the job loss insurance policy into a package; and
pricing and marketing the package.

2. The method of claim 1, wherein the step of pricing and marketing the package comprises setting a price for the package so as to be competitive with mortgage insurance products without job loss protection.

3. The method of claim 2, further comprising a step of adjusting the pricing and specifications of the package, including considering the effect of providing the job loss protection on the cost of providing the mortgage insurance.

4. The method of claim 3, wherein the step of adjusting the pricing and specifications of the package is performed based on information relating to an individual consumer.

5. A system for assembling and marketing insurance packages including a combination of mortgage insurance and additional insurance components, comprising:
a risk data repository for storing risk information to be used in determining the risk and cost of providing insurance packages;
an insurance data repository including information about available insurance components, the repository including information about a mortgage insurance component and additional insurance components; and
a risk evaluator for determining risks and costs associated with providing insurance, the risk evaluator being operative to compute overall risk and cost for a combined package and adjust parameters of the package components to optimize the risk and cost of the package.

6. The system of claim 5, further including a package terms development module for receiving desired criteria for an insurance package and developing a set of terms meeting those criteria and wherein the package terms development module passes the desired criteria to the risk evaluator and the risk evaluator produces optimized risk and cost information for a package meeting the desired criteria.

7. The system of claim 6, further comprising an operator interface module allowing submission of criteria to be used in developing insurance packages to be made available and wherein terms meeting the criteria are presented to an operator using the operator interface module.

8. The system of claim 7, further comprising a consumer interface module allowing submission by a consumer of criteria for a specific insurance package and wherein terms meeting the criteria are presented to the consumer using the consumer interface module.

9. The system of claim 8, further including a package negotiation module operative to receive an indication from a consumer to commit to coverage and to assemble and store details of the coverage package and the commitment for coverage.

10. The system of claim 9, wherein the insurance packages assembled and marketed include a combination of mortgage insurance and job loss insurance, and wherein the additional insurance components whose information is stored in the insurance data repository include job loss components.

11. The system of claim 10, wherein the data repositories and modules are implemented in the form of software hosted on a data processing system.

12. The system of claim 11, wherein the data processing system is operative to receive inquiries and commands from external computers over a publicly accessible network and to transfer information to the external computers over the publicly accessible network.

13. The system of claim 12, wherein the publicly accessible network is the Internet.

14. A method of developing and marketing combined packages of insurance including mortgage insurance and job loss insurance, comprising the steps of:
collecting and storing data related to risks and costs of providing insurance;
developing and storing details of insurance components to be made available in the form of combined packages, the packages including a mortgage insurance component and a job loss insurance component; and
evaluating risks and costs associated with providing a package of insurance including mortgage insurance and job loss insurance, evaluation comprising evaluating each component of the package, evaluating the combined risk and cost of the package as a whole and adjusting parameters of the package to optimize the risk and cost of the package.

15. The method of claim 14, further including receiving a set of criteria for an insurance package, and computing optimized risk and cost information to develop an optimized set of cost information and package parameters for a package meeting the criteria.

16. The method of claim 15, wherein the step of receiving the set of criteria comprises receiving a set of criteria for an insurance package required by a consumer and further comprising a step of providing the consumer with cost information and package parameters for a package meeting the criteria.

17. The method of claim 16, wherein the step of receiving a set of criteria for an insurance package includes receiving the criteria as electronic data transferred over a computer network and the step of computing optimized risk and cost information includes retrieving risk and cost information stored in an electronic database and performing electronic data processing on the criteria for the insurance package and on the risk and cost information to develop an optimized set of parameters for the insurance package.

18. The method of claim 17, wherein the step of receiving the set of criteria for an insurance package includes presenting hypertext forms for display on a customer computer and receiving a submission of information entered using the hypertext forms.

19. A software program running on a computer, operative to:
receive and store data related to risks and costs of providing insurance;
store details of insurance components to be made available in the form of combined packages, the packages including a mortgage insurance component and a job loss insurance component; and
evaluate risks and costs associated with providing a package of insurance including mortgage insurance and job loss insurance, evaluation comprising evaluating each component of the package, evaluating the combined risk and cost of the package as a whole and adjusting parameters of the package to optimize the risk and cost of the package.
